(19) United States
(12) Patent Application Publication
(10) Pub. No.: US 2007/0064267 A1
(43) Pub. Date: Mar. 22, 2007

(54) IMAGE PROCESSING APPARATUS

(76) Inventors: Akira Murakata, Tokyo (JP); Hiroyuki Kawamoto, Kanagawa (JP); Toshiya Hikita, Tokyo (JP); Tomoyuki Yoshida, Tokyo (JP); Takumi Nozawa, Kanagawa (JP); Satoshi Ohkawa, Tokyo (JP); Shuji Kimura, Kanagawa (JP); Manabu Komatsu, Tokyo (JP); Atsushi Togami, Kanagawa (JP); Takeharu Tone, Kanagawa (JP); Toshimi Yamamura, Kanagawa (JP); Yasunobu Shirata, Tokyo (JP); Yukihiko Tamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/470,913

(22) Filed: Sep. 7, 2006

(30) Foreign Application Priority Data
Sep. 16, 2005 (JP) 2005-270291

(51) Int. Cl. G06F 3/12

(52) U.S. Cl. 358/1.15; 358/1.13

(57) ABSTRACT

In an image processing apparatus including an image reading unit that obtains electronic image data obtained by reading a document, an image writing unit that prints the image data on transfer paper, a memory unit that stores the image data and auxiliary data of the image data, an external I/F unit that transmits and receives the image data to and from an external unit, a first image data processing unit that processes the image data from the image reading unit, a second image data processing unit that processes the image data from the memory unit, and a bus control unit that connects each of the units, a recognition function through image processing and an image processing function based on the recognition result are independently provided.

### CROSS-REFERENCE TO RELATED APPLICATIONS

The present document incorporates by reference the entire contents of Japanese priority document, 2005-270291 filed in Japan on Sep. 16, 2005.

### BACKGROUND OF THE INVENTION

1. Field of the Invention

The present invention relates to image processing apparatuses and, in detail, to image processing technology and image processing recognition technology for digital images.

2. Description of the Related Art

With the development of reading devices using a line sensor made from a charge coupled devices (CCD) optical-electrical converting element and toner writing devices through laser irradiation, digital copiers have emerged for making copies based on digitized image data from analog copiers.

With the emergence of digital copiers, compatibility with other devices handling digital image data has been increased. In addition to functions as copiers, digital copiers now have combined functions, such as a facsimile function, a printer function, and a scanner function, and are therefore called digital multifunction product (MFP).

With the advancement of technologies related to MFPs, such as increased memory capacity for hard disk drives (HDDs), reduced cost, higher-speed and widespread network communications, improvement in processing capability of central processing units (CPUs), and advanced technology regarding digital image data (such as compression technology), functions incorporated in MFPs have been varied.

The way to use MFPs has also been varied. For example, a small-sized MFP is placed beside a personal computer (PC) as a pair, and an operator can easily use MFP's functions as a copier, facsimile, printer and scanner. A middle-sized MFP with a certain degree of productivity and functions, such as sorting, hole punching, and stapling, being available, is shared by a plurality of people in each department and section in a company. A large-sized MFP with high productivity and quality and many functions is used in a copy-related department of a company, or a company itself dedicated to copy-related tasks.

MFPs have various sizes from small to large. Some of the functions are common to MPFs of all sizes, but other functions are peculiar to each size.

For example, in a large-sized MFP, processing on paper after plotting, such as hole punching, stapling, and folding, and electronic filing together with copying are demanded. In a small-sized MFP, enhancement of Internet fax and PC fax and, for the purpose of personal use, high-quality image printing on dedicated paper are demanded.

Conventionally, in such a varying MFP market, systems combined with required functions for each class have been constructed and presented for sale.

The importance of information value in business has already been recognized. It has also been demanded that information be transmitted not only quickly, accurately, and reliably, but also intelligibly and effectively.

With high speed and widespread of communication technology, larger-capacity, lower-cost, and small-sized memory, and higher performance of PCs, a new function has been provided to efficiently handle information using digital data. Such a new function has been desired to be provided and incorporated also in MFPs that handle digital image data, which is part of digital data.

MFPs using digital data to support copier, scanner, facsimile, and HDD storage application have been emerged and used for various purposes as being connected to a network. In a reading device, a document may be read as being skewed, or may be skewed due to delivery by a document feeder (DF), which is often used for bulk printing. As a result, output paper data or electronic data is skewed. In addition, a user may set a document without as being unaware where the document is upside down, thereby causing paper data or electronic data to be output with the upside and downside being the same as those at the time of reading. To get around this problem, it has been desired that document skew correction and automatic upside-down correction are performed at an MFP device side without making a user aware of such correction.

In one way to use an MFP for business purposes, a document has to be placed in a correct direction in advance by a user himself or herself so that the upside and downside of the document are properly in place for output. When digital data is processed by an optical character reader (OCR) for conversion to text data, there is a problem of a decrease in recognition rate due to a skew of the document.

To handle digital images from an MFP, one type of MFP called an IT machine has been emerged, which is connected to a PC to incorporate a function of automatically determining an upside-down for rotation and a function of determining a subtle skew angle of the document for correction, which is called a skew correction function. On the MFP in conjunction with its PC, an upside-down and a skew of the document is recognized and corrected.

Since such an MFP recently emerged with an upside-down identification function and a skew correction function optionally uses a PC so as to operate in conjunction with the PC, these functions cannot be used unless the PC is included as standard, requiring cost for PC as an option. Also, even if an optional PC is incorporated to construct a system, the system may only support an HDD storage application. If a copy, scanner, or facsimile function is selected, the document has to be placed in a correct direction by the user himself or herself. Even if the document is read as being skewed, the output result is not corrected.

With the improvement of processing capability of the CPU of the MFP itself and an increase in capacity of memory and HDD, it is desired that the functions be incorporated as standard functions in the MFP side at low cost even without an optional PC. It is also desired that the MFP include functions of upside-down identification and skew correction recognition for image correction, the functions capable of supporting all of the variety of applications handled by the MFP, such as copy, scanner, facsimile, and HDD applications.

In Japanese Patent Application Laid-Open No. 2002-111988, for image data accumulated and stored, a second image processing means for image processing is provided. However, an object of providing such a second image process is to increase a processing speed, instead of supporting image processing recognition or switching of processing by such recognition processing.

In one scheme where a correction process is performed based on a skew of the document surface with respect to the reading device, a correction process can be performed on an image input from the reading device, but the scheme cannot support a printing application input from a network. Since a correction process is targeted for image data, auxiliary information of the image is not corrected. Therefore, unlike an HDD storage application, it is not assumed that data is reused after a while for again performing image processing.

In Japanese Patent Application Laid-Open No. 9-200507, a skew is detected in data of a read document from a DF for correction. This scheme assumes reading at a DF, and therefore does not support reading at a printing plate. Another problem is that the scheme cannot support a printing application input from a network. Since a correction process is targeted for image data, auxiliary information of the image is not corrected. Therefore, unlike an HDD storage application, it is not assumed that data is reused after a while for again performing image processing.

In Japanese Patent Application Laid-Open No. 2001-358914, a reading device itself includes a skew detection function and performs a correction process based the detection result. This scheme assumes CCD reading at the reading device, and therefore the scheme cannot support a printing application input from a network. Also, the scheme can support skew correction, but upside-down identification is not performed. Since a correction process is targeted for image data, auxiliary information of the image is not corrected. Therefore, unlike an HDD storage application, it is not assumed that data is reused after a while for again performing image processing.

On the other hand, in recent years, with an advanced integration of an increase in capacity and a decrease in cost of memory with MPF's functions of converting a paper document to digital image data, the MFP has been increasingly used in a manner such that digital image data is accumulated and stored in the MFP, and is then output again when information about that data is required.

When digital image data accumulated and stored in the MFP is output again, it is often the case that some time has elapsed since data accumulation and storage. During that period, the state of an operator for re-output, that is, requests and needs, is often changed. Therefore, a problem occurs such that changes in requests and needs cannot be addressed.

For example, it may not be possible to transmit, by facsimile, digital image data stored in the MFP at the time of using a copier function. Even if that is possible, there are problems, such as a large difference in image quality and a significant degradation in productivity.

For a recognition process through image processing and a correction process based on the recognition process, in consideration of reuse, what is required are a detecting unit optimal in an architecture assuming reuse, correction on image data for other image processing, and correction on auxiliary information of that image.

For example, when an HDD storage function is used, upside-down identification and skew correction are performed, and the results are stored in the HDD in the MFP. Now, assume when the image subjected to upside-down identification and skew correction is only to be printed out and when the image is to also transmitted by facsimile. For printout, separation data, which is auxiliary information of that image, is used for image processing for output. For facsimile transmission, also based on the separation data, which is auxiliary information of that image, image processing is performed to enhance character portion for transmission. In the case of storage in the HDD, if upside-down identification and skew correction are performed only on the image and a similar rotation process is not performed on the auxiliary information of the image, there is a problem in which image processing at the time of printout and facsimile transmission cannot be optimally performed.

### SUMMARY OF THE INVENTION

It is an object of the present invention to at least partially solve the problems in the conventional technology.

According to an aspect of the present invention, an image processing apparatus includes an image reading unit that obtains image data by scanning a document; an image writing unit that prints the image data on a recording medium; a storage unit that stores the image data and auxiliary information relating to the image data; a transmitting/receiving unit configured to transmit the image data to an external device and receive image data from the external device; a first image data processing unit that processes the image data obtained by the image reading unit; a second image data processing unit that processes the image data present in the memory unit; and a bus control unit that connects each of the units. A recognition function through image processing and an image processing function based on the recognition result are independently provided.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a drawing of a general system structure of an image processing apparatus according to an embodiment of the present invention;

FIGS. 2A to 2C are drawings of an example in which a recognition process at a second image-data processing device and a correction process based on the recognition-process result;

FIG. 3 is a drawing of the structure of image processing in the second image-data processing device;

FIG. 4 is a drawing of an example of input and output of an upside-down identification process;

FIG. 5 is a drawing of an example of input and output of a skew correction process;

FIG. 6 is a drawing of an example of an operation display device 110;

FIG. 7 is a drawing of an example of configuration of a PDF file;

FIG. 8 is a drawing of an example of a PDF header with an image direction, a rotation angles and an amount of movement being added;

FIG. 9 is a drawing of an example a list components of information of an input image 205 and auxiliary information 206 for color image;

FIG. 10 is a drawing of a process flow in time series in an upside-down rotation process 303;

FIG. 11 is a drawing of a process flow in time series of a skew correction process 304;

FIG. 12 is a drawing of a relation between each process and an image direction;

FIG. 13 is a drawing of an entire process flow of a recognition process 203;

FIG. 14 is a drawing of an example of performing an upside-down rotation process 1002 on all planes based on the detection result of plane information obtained through an upside-down identification process 301;

FIG. 15 is a drawing of an example of performing a skew correction process 1102 on all planes based on the detection result of plane information obtained through a skew detection process 302;

FIG. 16 is a drawing of an example of switching whether to perform the upside-down rotation process 1002 on separation data based on application information in the upside-down identification process 301; and

FIG. 17 is a drawing of an example of switching whether to perform the skew correction process 1102 on separation data based on application information in the skew detection process 302.

### DETAILED DESCRIPTION OF THE PREFERRED EMBODIMENTS

Exemplary embodiments of the present invention are described below.

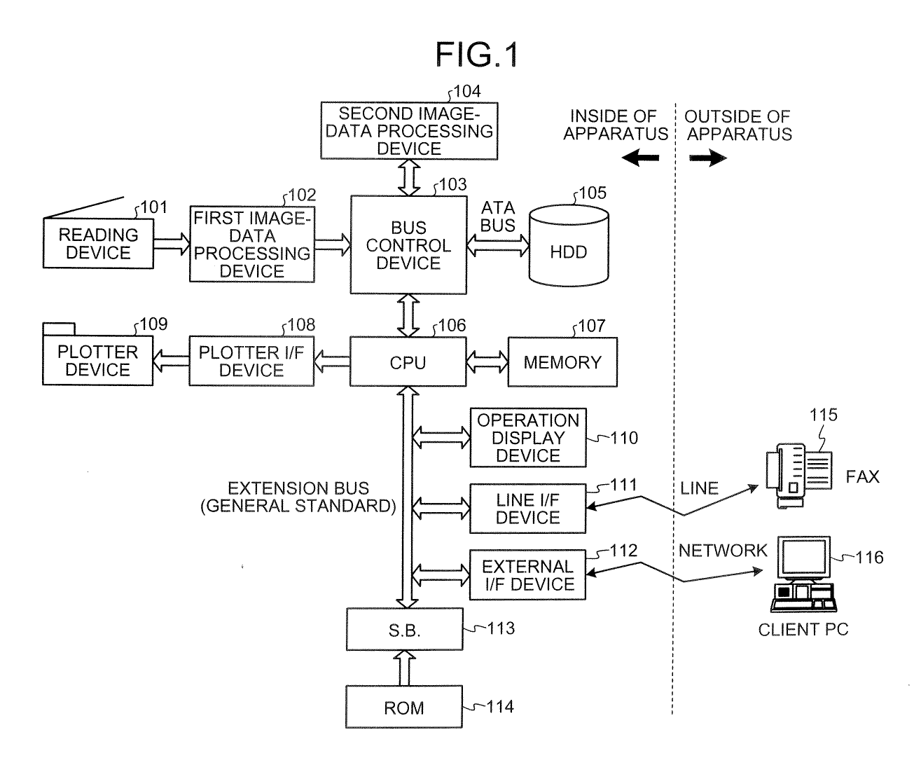

First, FIG. 1 depicts the general system structure of an image processing apparatus according to an embodiment of the present invention.

A reading device 101 includes a line sensor composed of a CCD optical-electrical converting element, an analog-to-digital (A/D) converter, and driving circuits therefor. The reading device 101 scans a document that is set and, from contrast information of the document, generates digital image data of eight bits for each color of RGB.

A first image-data processing device 102 processes the digital image data from the reading device 101 for unification into a predetermined characteristic, and output the resultant data. In this apparatus, the characteristic of the reading device 101 is not changed, and outputs are image data with a defined and unified characteristic. Therefore, with an application-specific integrated circuit (ASIC), that is, a dedicated image processing circuit, a predetermined image process is achieved.

A bus control device 103 is a control device for a data bus for exchanging various data, including image data and control command required in the digital image processing apparatus, and also has a bridging function among various types of bus standards. In the present embodiment, the first image-data processing device 102, a second image-data processing device 104, and a CPU 106 are connected to a Peripheral Component Interconnect (PCI) or PCI-Express bus and an HDD 105 via an Advanced Technology Attachment (ATA) bus for serving as an ASIC.

The second image-data processing device 104 performs an image process suitable for an output destination specified by a user on the digital image data with a predetermined unified characteristic obtained by the first image-data processing device 102, and outputs the resultant data. In an image processing recognition process of the present apparatus, since the input image data of this second image-data processing device 104 has a unified characteristic, a recognition process is performed at a previous stage of the image process suitable for an output destination, and an image process based on the result of the recognition process is performed at a subsequent stage.

The HDD 105 is a large-sized storage device for storing electronic data for use even in a desk-top personal computer. In the present digital image processing apparatus, the HDD 105 mainly stores digital image data and auxiliary information of the digital image data. In the present embodiment, a hard disk for ATA bus connection standardized by extending Integrated Drive Electronics (IDE) is used.

The CPU 106 is a microprocessor for controlling the entire digital image processing apparatus. In the present embodiment, the CPU 106 is used to perform sequence management for the entire control, request management for each device, hardware setting management, timing management, task management for a plurality of user requests, and image processing by software of the second image-data processing device 104.

A memory 107 is a non-volatile memory temporality storing a program, intermediate process data, and image data when the CPU 106 executes programmed contents for control. With an object-oriented program, object data for each control unit is stored. Upon a user request, a control process is carried out according to the responsibility of each object.

A plotter I/F device 108 receives digital image data composed of cyan, magenta, yellow and black (CMYK) transmitted via a general-standard I/F upon a print request from the CPU 106, and then performs a bus bridge process for outputting the received data to a dedicated I/F of a plotter device 109. The general-standard I/F for use in the present embodiment is a PCI or PCI-Express bus.

The plotter device 109 outputs the received digital image data composed of CMYK onto transfer paper by using an electrophotography process with laser beams.

A south bridge (S.B.) 113 is a general-purpose electronic device of one type of a chip set for use in personal computers.

A ROM 114 is a memory having stored therein a control program for use when the CPU 106 controls the present digital image processing apparatus. The ROM 114 has also stored therein image-processing assembler code for middleware (hereinafter, a digital signal processor (DSP) in the second image-data processing device 104, as well as image-processing parameters for image processing, such as a filtering process and γ process. The assembler code and the image-processing parameters stored in advance in the ROM 114 are downloaded for use in image processing at the DSP.

An operation display device 110 is a unit for interface between the present digital image processing apparatus and a user interface, and includes a liquid-crystal display (LCD) and a key switch. Various states and operation schemes of the apparatus are displayed on the LCD, and a key-switch input from the user is detected. In the present embodiment, the operation display device 110 is connected to the CPU 106 via a PCI or PCI-Express bus, and supports copier, scanner, HDD storage, and facsimile transmission functions.

A line I/F device 111 is a device that connects the PCI and PCI-Express buses and a telephone line together. With this device 111, digital image processing apparatus can exchange various data via the telephone line.

A facsimile 115 is a normal facsimile, receiving image data from the present digital image processing apparatus via the telephone line.

An external I/F device 112 is a device that connects PCI and PCI-Express buses and an external device. With this device 112, digital image processing apparatus can exchange various data with the external device. In the present embodiment, an Internet Protocol (IP) address is assigned to a device side, and its connection I/F has a Transmission Control Protocol/Internet Protocol (TCP/IP) connection.

A client PC 116 is a so-called personal computer. In the present embodiment, via application software and drivers installed on this personal computer, the user performs scanner reading and printout with a Twain driver.

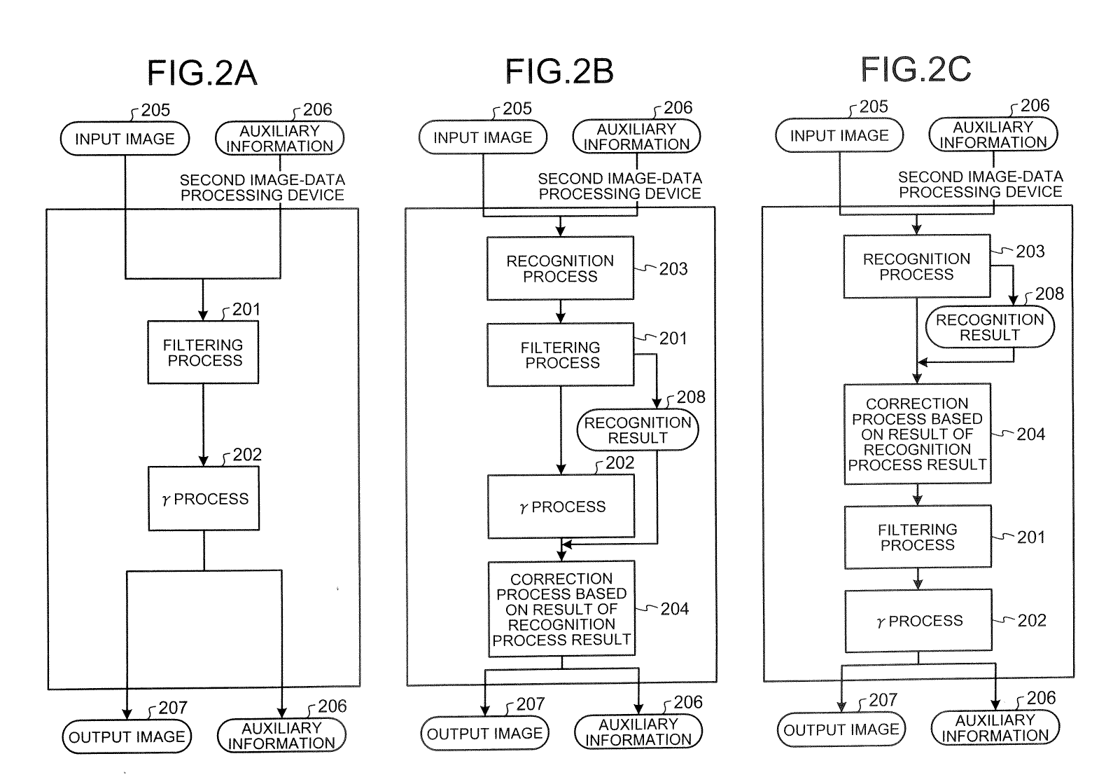

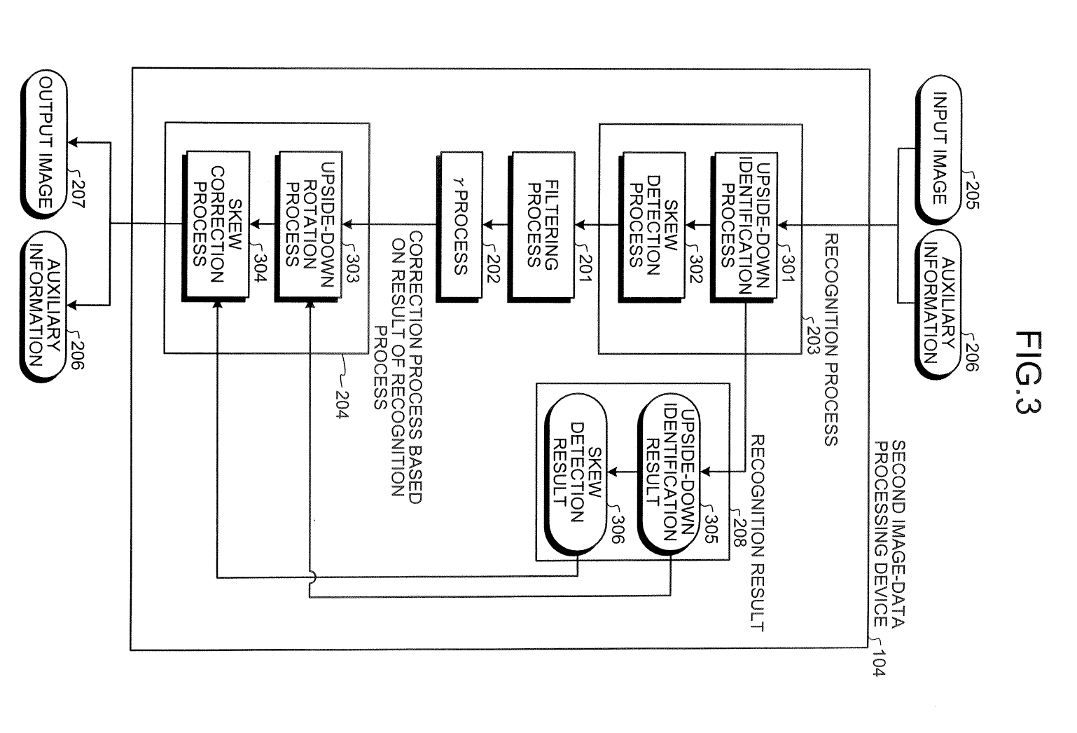

FIGS. 2A to 2C depict an example in which a recognition process at the second image-data processing device 104 and a correction process based on the recognition-process result.

For example, in the case of a copying operation, the image digitized in the reading device 101 is input to the system. Based on that data, the first image-data processing device 102 converts the image into an image with a certain characteristic (such as a color space) being unified. An input image 205 of the second image-data processing device 104 is based on the digital image data unified by the first image-data processing device 102. Auxiliary information 206, on the other hand, is auxiliary information of the input image 205. This auxiliary information includes input information at the operation display device 110 (document mode, scaling ratio, image size, etc) and separation data (character/photograph/dots) corresponding to each pixel of the image data. The separation data is generated by the first image-data processing device 102.

FIG. 2A depicts a configuration in which a recognition process 203 and a correction process 204 based on the recognition-process result are not performed. For print output, image processing including a filtering process 201 and a γ process 202 is performed so as to produce an output suitable for the plotter device 109, and then an output image 207 and auxiliary information 206 are output. The filtering process 201 and the γ process 202 uses the auxiliary information 206 to switch the process and the image-processing parameters. By contrast to this basic structure, in the embodiment, the recognition process 203 and the correction process 204 based on the recognition-process result are added.

Also, with these two processes independently provided, the structure of the second image-data processing device 104 can be changed as depicted in FIGS. 2B and 2C. In the recognition process, the input image 205 and the auxiliary information 206 are used to recognize a characteristic amount of the image to obtain a recognition result 208. In a process at a subsequent stage, that is, in the correction process 204 based on the recognition-process result, based on the recognition result 208, a correction process is performed on the input image 205 and the auxiliary information, such as separation data, through image processing.

The second image-data processing device 104 has a structure depicted in FIG. 2B to prevent the filtering process 201 and the γ process 202, which are image processing for output, from being affected by changes in image quality due to the correction process 204 based on the recognition-process result.

FIG. 3 is a drawing of the structure of image processing in the second image-data processing device. For description of the operation, an example in the case of a copying operation is used in which an image digitized in the reading device 101 is input to the system.

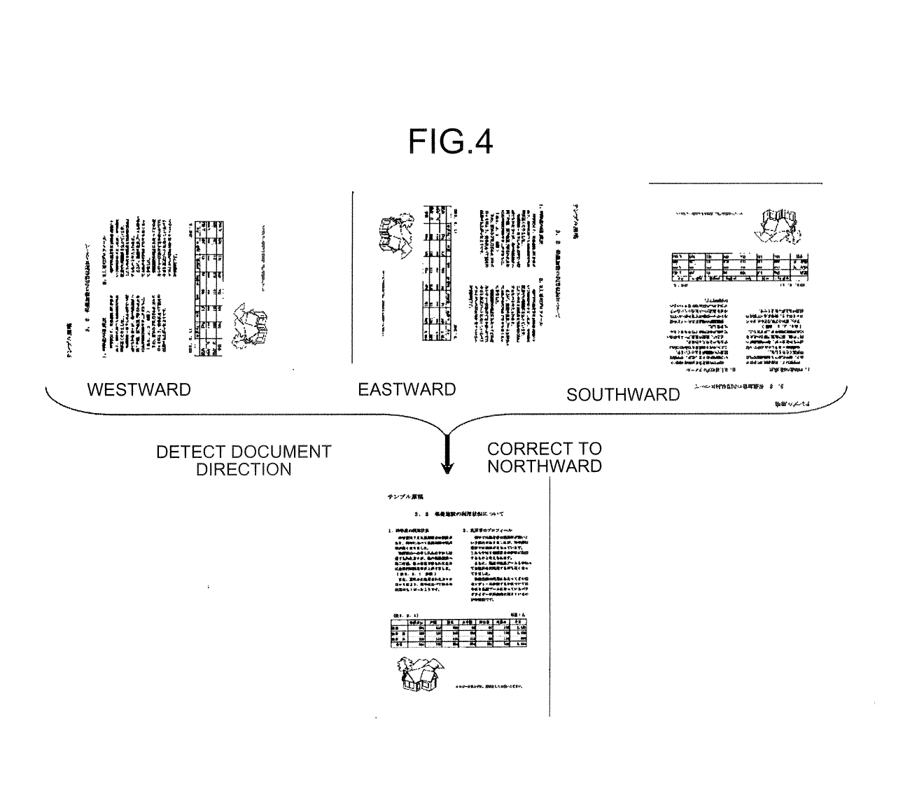

As a recognition process 203, an upside-down identification process 301 and a skew detection process 302 are performed. In the upside-down identification process 301, a direction of the image is recognized based the characteristic amount in the image. An upside-down identification result 305 can be any one of the following five types: north, south, east, west, and direction unknown. FIG. 4 depicts an example of input and output of the upside-down identification process. Three input images are corrected so that images, characters, and graphics are oriented northward.

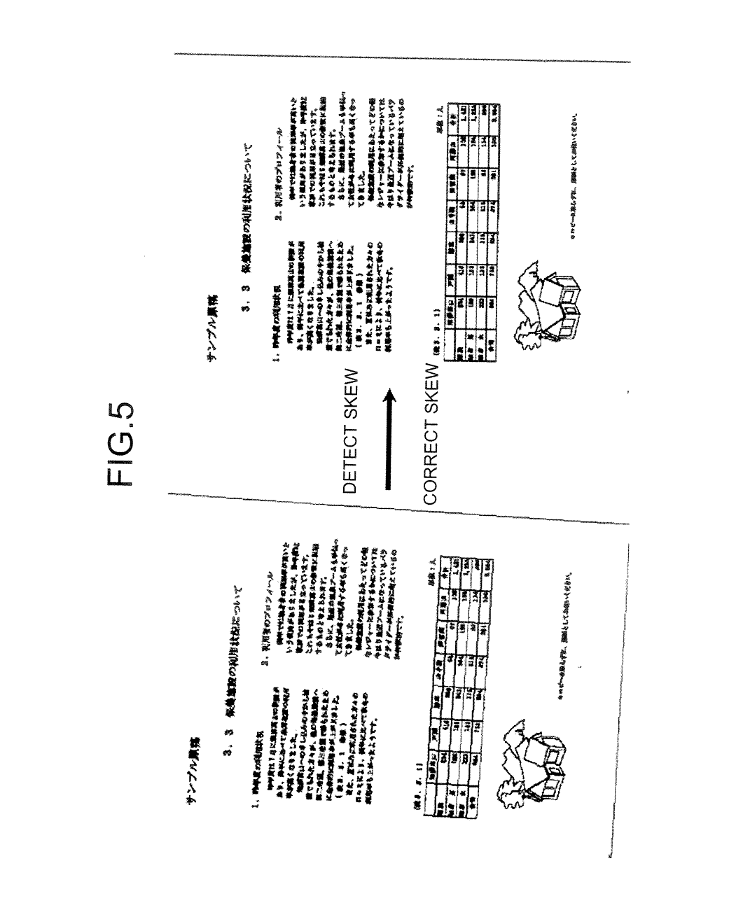

In the skew detection process 302, a skew of the image is detected based on the characteristic amount in the image. A skew detection result 306 is a skew angle (±X degrees) and a skew decision result (whether a skew angle has been successfully detected). FIG. 5 depicts an example of input and output of the skew correction process. The input image input as being skewed at a certain angle θ is rotated so as not to be skewed.

The upside-down identification process 301 and the skew detection process 302 of the recognition process 203 are performed first by the second image-data processing device 104, because the recognition accuracy would be affected by the filtering process 201, the γ process 202, and others. Thus, a detection process is performed in a state before any image processing is performed, thereby allowing improvement in detection accuracy.

The upside-down identification process 301 and the skew detection process 302 of the recognition process 203 are performed, the upside-down identification result 305 and the skew detection result 306 of the recognition result 208 are output, and then the filtering process 201 and -the γ process 202 are then performed. The filtering process 201 and the γ process 202 are processes for changing the characteristic of the image, but do not affect positional information. Therefore, there is not particularly a problem when the recognition result 208 obtained through detection without the filtering process 201 and the γ process 202 is used for the image subjected to the filtering process 201 and the γ process 202.

An upside-down rotation process 303 and a skew correction process 304 of the correction process 204 based on the recognition-process result are performed on the image data subjected to image processing suitable for the output device.

In the upside-down rotation process 303, the input image 205 is rotated in units of 90 degrees based on the upside-down identification result 305. If the upside-down identification result 305 indicates direction unknown, the upside-down rotation process 303 is not performed, that is, skipped, and the input is output as it is.

In the skew correction process 304, the input image 205 is rotated by a subtle angle based on the skew detection result 306. If the skew detection result 306 indicates that the skew angle detection has failed, the skew correction process 304 is not performed, that is, skipped, and the input is output as it is.

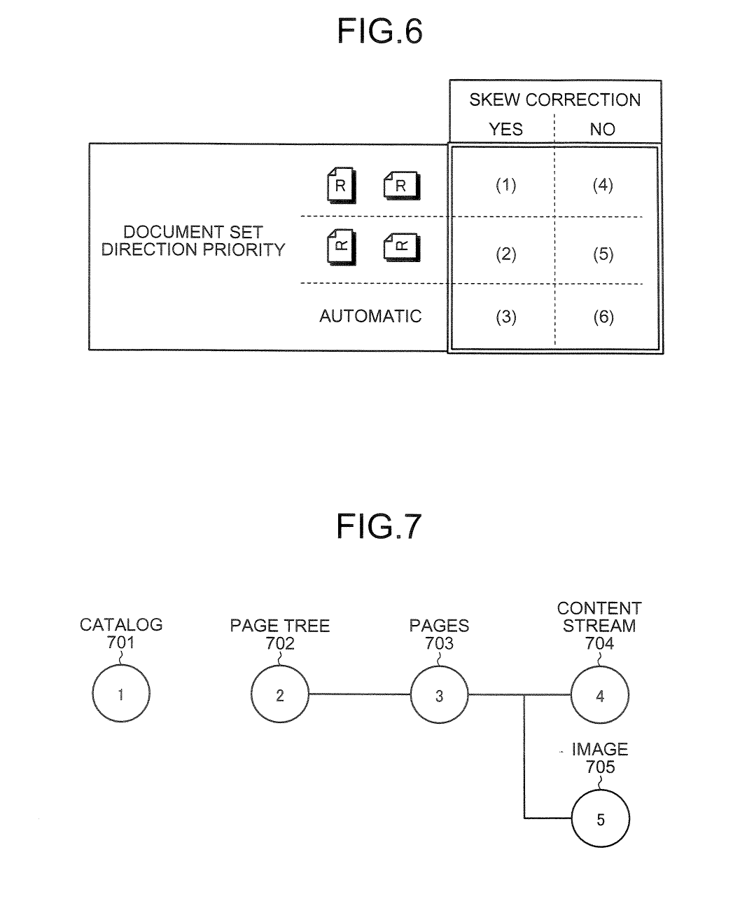

FIG. 6 depicts an example of the operation display device 110. In addition to a mode in which the user is prompted to determine a direction, automatic direction determination (the upside-down identification process 301 and the upside-down rotation process 303) and a skewed-document correction process (the skew detection process 302 and the skew correction process 304) are added to a user interface. This user interface can handle the upside-down identification function and the skew correction function independently, and prompts the user to select one of six options (1) to (6).

(1) The user does not select upside-down identification, sets the document eastward by himself or herself, and does not select the skew correction function. In the case of (1), in FIG. 3, the upside-down identification process 301 and the skew detection process 302 of the recognition process 203 are skipped. An image direction “eastward” is stored in the auxiliary information 206 of the image. In the upside-down rotation process 303 of the correction process 204 based on the recognition-process result, the eastward direction is corrected to a northward direction. The skew correction process 304 is skipped.

(2) The user does not select upside-down identification, sets the document northward by himself or herself, and does not select the skew correction function. In the case of (2), in FIG. 3, the upside-down identification process 301 and the skew detection process 302 of the recognition process 203 are skipped. An image direction “northward” is stored in the auxiliary information 206 of the image, and the upside-down rotation process 303 and the skew correction process 304 of the correction process 204 based on the recognition-process result are skipped.

(3) The user selects automatic direction determination, and therefore upside-down identification is selected. The direction of the image to be read is unknown, and the skew correction function is not used. In the case of (3), in FIG. 3, a detection process is performed in the upside-down identification process 301 of the recognition process 203, and then the upside-down identification result 305 is output. The skew detection process 302 is skipped. In the upside-down rotation process 303 of the correction process 204 based on the recognition-process result, the image is rotated by using the upside-down identification result 305. If the upside-down identification result 305 indicates direction unknown, the input image is output as it is. The skew correction process 304 is skipped.

(4) The user does not select upside-down identification, sets the document eastward by himself or herself, and selects the skew correction function. In the case of (4), in FIG. 3, the upside-down identification process 301 of the recognition process 203 is skipped, whilst the skew detection process 302 is performed and the skew detection result 306 is output. An image direction eastward” is stored in the auxiliary information 206 of the image. In the upside-down rotation process 303 of the correction process 204 based on the recognition-process result, the eastward direction is corrected to a northward direction. The skew correction process 304 is performed based on the skew detection result 306. If skew angle detection has failed in the skew correction process 304, the input image is output as it is.

(5) The user does not select upside-down identification, sets the document northward by himself or herself, and selects the skew correction function. In the case of (5), in FIG. 3, the upside-down identification process 301 of the recognition process 203 is skipped, whilst the skew detection process 302 is performed and the skew detection result 306 is output. An image direction “northward” is stored in the auxiliary information 206 of the image, and the upside-down rotation process 303 of the correction process 204 based on the recognition-process result is skipped. The skew correction process 304 is performed based on the skew detection result 306. If skew angle detection has failed in the skew correction process 304, the input image is output as it is.

(6) The user selects automatic direction determination, and therefore upside-down identification is selected. The direction of the image to be read is unknown, and the skew correction function is selected. In the case of (6), in FIG. 3, a detection process is performed in the upside-down identification process 301 of the recognition process 203, and then the upside-down identification result 305 is output. The skew detection process 302 is performed, and then the skew detection result 306 is output. In the upside-down rotation process 303 of the correction process 204 based on the recognition-process result, the image is rotated by using the upside-down identification result 305. If the upside-down identification result 305 indicates direction unknown, the input image is output as it is. The skew correction process 304 is performed based on the skew correction detection result 306. If skew angle detection has failed in the skew correction process 304, the input image is output as it is.

In the embodiment, described are an example of a user interface of the operation display device 110 for supporting an input from the reading device 101 in a copying operation, and an example of operation of the second image-data processing device 104 at the time of selection. If any one of (1) to (6) can be selected at a user interface in the case of setting the scanner operation from a client PC, such as Twain, upside-down identification and a skew correction process can be selected upon a network input, thereby making the system executable for such a case.

FIG. 7 depicts an example of configuration of a PDF file. In this example, an example of a file format of a PDF file selectable at the time of distribution in a scanner application. A catalog object 701, a page tree 702, and pages 703, which are absolutely required, are present. A content stream 704 and an image object 705, which are associated with an image object read from the reading device 101, are present. This example depicts a single PDF format in which one image is made into a PDF file.

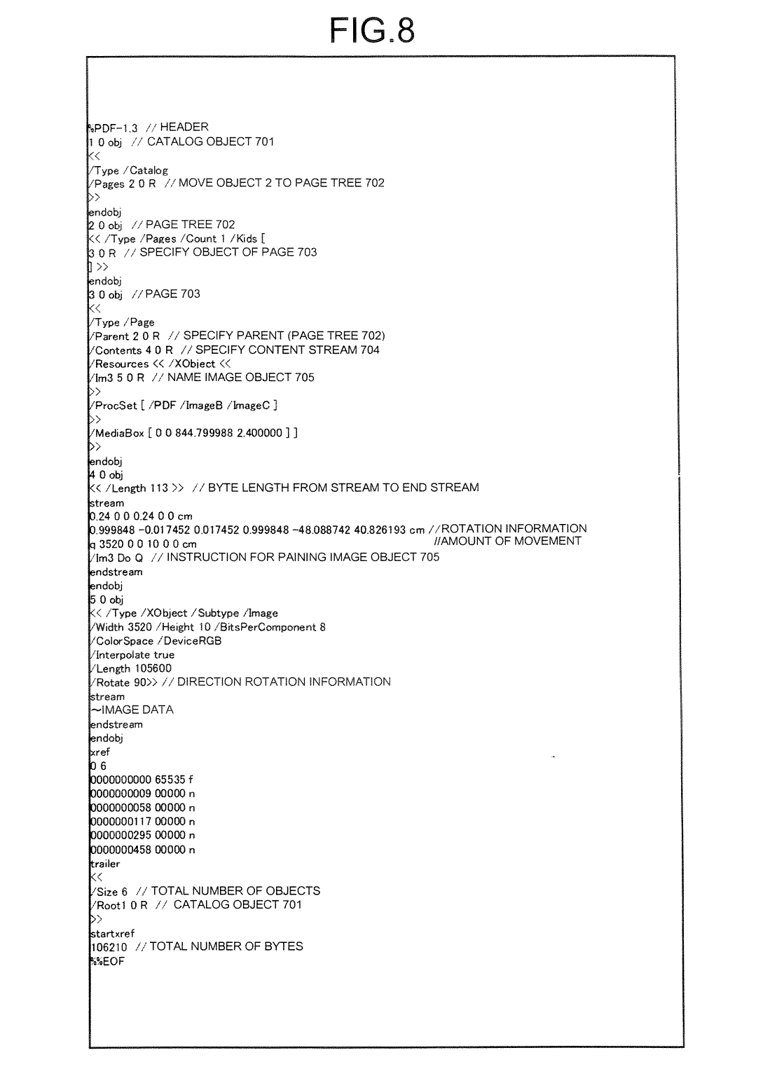

FIG. 8 is a drawing of an example of a PDF header with an image direction, a rotation angle, and an amount of movement being added. This is excerpted from header information of the PDF file with the configuration shown in FIG. 7. In practice, character strings after “//” are not written in the PDF file. These are merely shown for the purpose of description.

The result obtained through determination in the upside-down identification process 301 in the second image-data processing device 104 in the third embodiment is reflected too the PDF header. Then, a viewer installed in the client PC 116 recognizes the header information at the time of display, and displays the image as being rotated.

In the example of FIG. 8, it is determined in the upside-down identification process 301 that the upside-down identification result 305 indicates westward. Format information (PDF output) of the output file is stored in the auxiliary information 206 of the image. In the upside-down rotation process 303, the actual image is not rotated, and thus the process is skipped.

In a process of encoding to a PDF file format performed in the CPU 106, the data is converted to a PDF file format. In the encoding process, a PDF header is generated. At the time of this header generation, the upside-down identification result 305 (westward) is read, and “/Rotate 90” is written, as shown in FIG. 8.

The client PC 116 activates the viewer to display the PDF file distributed as a PDF format. The viewer reads direction information added by the device when generating the PDF file, and rotates the direction of the image by 90 degrees in a clockwise direction.

In the example of FIG. 8, it is determined in the skew detection process 302 that the skew detection result 306 indicates a skew angle of 1 degree. The format information (PDF output) of -the output file is stored in the auxiliary information 206 of the image. In the skew correction process 304, the actual image is not rotated, and thus the process is skipped.

In a process of encoding to a PDF file format performed in the CPU 106, the data is converted to a PDF file format. In the encoding process, a PDF header is generated. At the time of this header generation, the skew detection result 306 is read, and “0.999848-0.017452 0.017452 0.999848” is written, as shown in FIG. 8.

The client PC 116 activates the viewer to display the PDF file distributed as a PDF format. The viewer reads rotation angle information added by the device when generating the PDF file, and rotates the image by 1 degree.

In the example of FIG. 8, it is determined in the skew detection process 302 that the skew detection result 306 indicates a skew angle of 1 degree. The format information (PDF output) of the output file is stored in the auxiliary information 206 of the image. In the skew correction process 304, the actual image is not rotated, and thus the process is skipped.

In a process of encoding to a PDF file format performed in the CPU 106, the data is converted to a PDF file format. In the encoding process, a PDF header is generated. At the time of this header generation, the skew detection result 306 is read, and “−48.08874240.826193” is written, as shown in FIG. 8. The amount of movement is calculated by using the following equations.
(the amount of movement in the main-scanning direction)=−(sub-scanning size of the image)*tan(−(skew angle))+A (A: offset)
(the amount of movement in the sub-scanning direction)=(main-scanning size of the image)*tan(−(skew angle))+B (B: offset)

The client PC 116 activates the viewer to display the PDF file distributed as a PDF format. The viewer reads amount-of-movement information added by the device when generating the PDF file, and parallel-translates the image by a specified number of pixels.

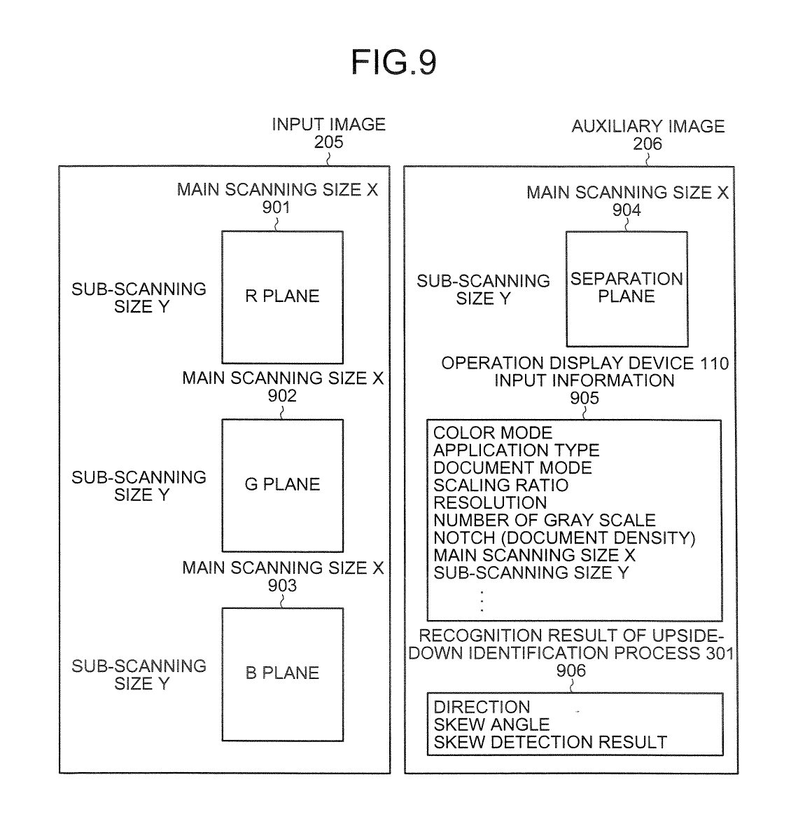

FIG. 9 depicts an example a list of components of the information of the input image 205 and the auxiliary information 206 for color image. These components are those constructing the input image 205, which is an input of the second image-data processing device 104 and the auxiliary information 206. These are also input information of the upside-down identification process 301 and the skew detection process 302 of the recognition process 203.

When color is selected, the second image-data processing device 104 receives, as the input image 205, three-plane image information including an R plane 901, a G plane 902, and a B plane, where an RGB color image, which is a unified color space, is in a one-dimensional array with an amount of a main-scanning size X by a sub-scanning size Y.

The auxiliary information 206 is broadly divided into a separation plane 904, input information 905 for the operation display device 110, and recognition result 906 of the upside-down identification process 301. In the information about the separation plane 904, an image in a one-dimensional array of the image size (the main-scanning size X by the sub-scanning size Y) with each pixel of the image information corresponding to N bits of the separation information. This separation plane 904 represents information generated by the first image-data processing device 102 from the characteristic of the input image.

The input information 905 for the operation display device 110 indicates settings set by the user. In the example of FIG. 9, the input information 905 includes color mode, application type, document mode, scaling ratio, resolution, the number of gray scale, notch (document density), main scanning size X, and sub-scanning size Y.

The recognition result 906 of the upside-down identification process 301 is a detection result recognized in the upside-down identification process 301 by the second image-data processing device 104. The recognition result 906 includes direction, skew angle, and skew detection result. Here, when the user does not select the recognition process, the direction in the recognition result 906 of the upside-down identification process 301 is set as the image direction specified by the user, and a skew angle of 0 degree and a skew detection result of no skew detection are stored, which are included in the information from the operation display device 110 about the selection. Referring to the preset recognition result 906 of the upside-down identification process 301, the upside-down identification process 301 and the skew detection process 302 of the recognition process 203, and the upside-down rotation process 303 and the skew correction process 304 of the correction process 204 based on the recognition-process result are selectively performed.

According to the embodiment, the upside-down rotation process 303 and the skew correction process 304 of the correction process 204 based on the recognition-process result has a feature in which a rotation is performed by one plane on the format in which the image information is stored by one plane in the input image 205 and the separation plane 904 in the auxiliary information 206.

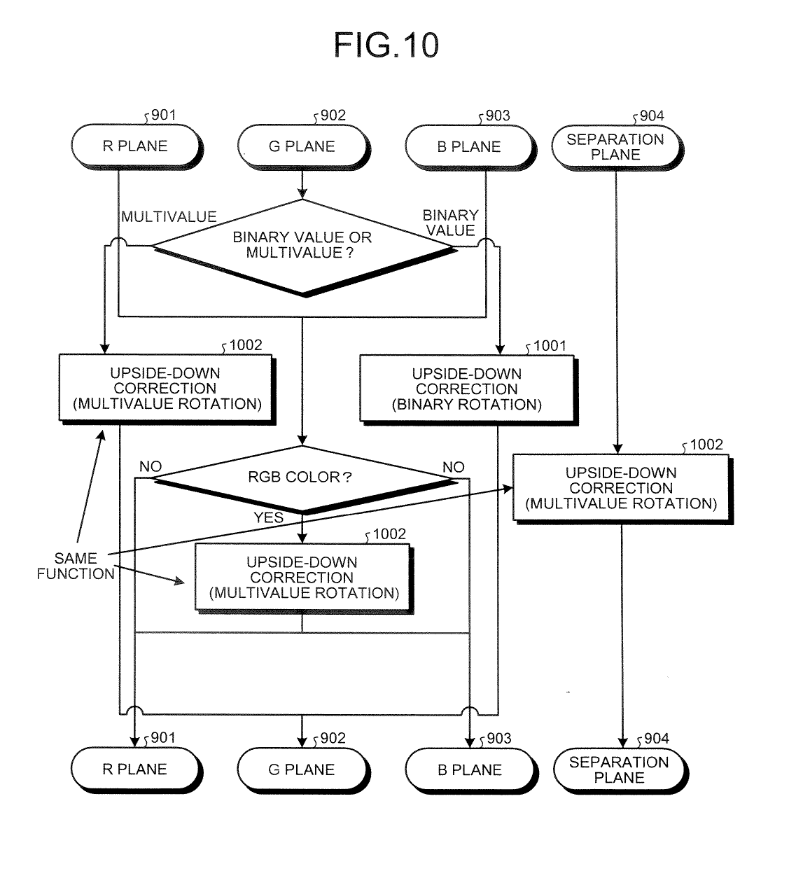

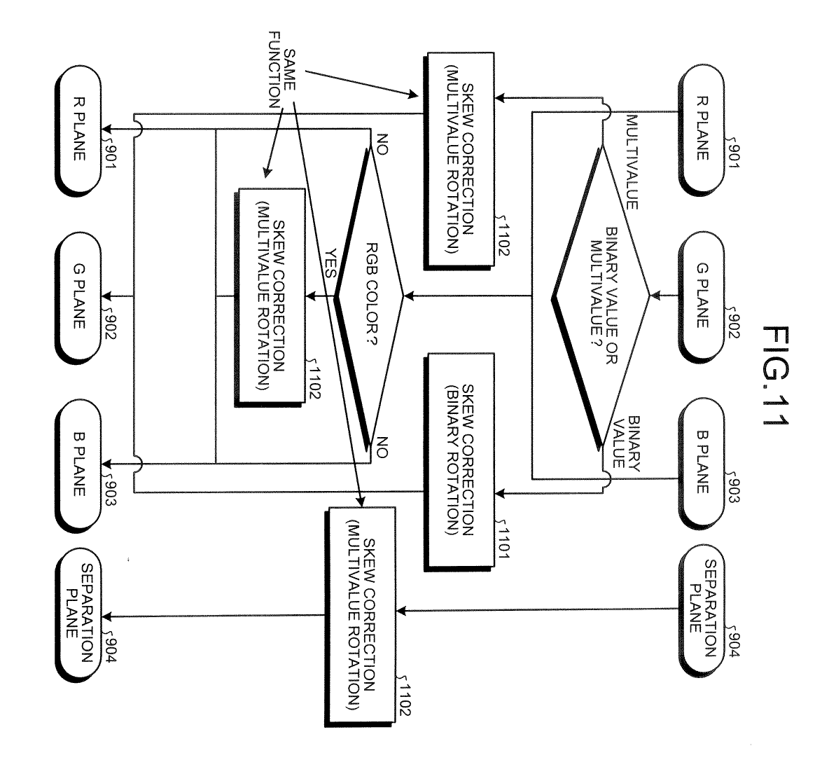

FIG. 10 depicts a process flow in time series in the upside-down rotation process 303 and FIG. 11 depicts a process flow in time series of the skew correction process 304. In the process flows of FIGS. 10 and 11, color information is also taken in consideration. In the case of binary and gray-scale mode, information is stored in the G plane 902. Therefore, rotation of the G plane is always performed. In the case of a binary image, image data is packed in one pixel of 1 bit. Therefore, in addition to the upside-down rotation process 303 and the skew correction process 304, upside-down rotation (binary rotation) 1001 and skew correction (binary rotation) 1101 for binary image are used for rotation. In the embodiment shown in FIGS. 10 and 11, in the case of a gray-scale, color image, the number of gray-scale is the same, and the number of gray-scale of the separation plane 904 is identical to the number of gray-scale of the image plane. For N bits of gray-scale, in addition to the upside-down rotation process 303 and the skew correction process 304, upside-down rotation (multivalue rotation) process 1002 and skew correction (multivalue rotation) 1102 for multivalue image (N image) are used for rotation.

The upside-down rotation process 303 and the skew correction process 304 depend on the number of gray-scale of the image. When the number of gray-scale of the separation plane 904 is different from the number of gray-scale of the image plane, the rotation process for the separation plane 904 is first constructed and executed.

By newly adding a rotation process, not only the images planes, that is, the R plane 901, the G plane 902, and the B plane, but also the separation plane 904 can be rotated.

In the present embodiment, the recognition process 203 includes the upside-down identification process 301 and the skew correction process 304. Alternatively, the recognition process 203 may also include a character recognition process through OCR and a bar-code recognition process. Also, text data may be added to the auxiliary information 206 and stored in the HDD serving as a secondary storage device. When the user selects an image stored in the HDD 105, a text search may be performed for improving search efficiency.

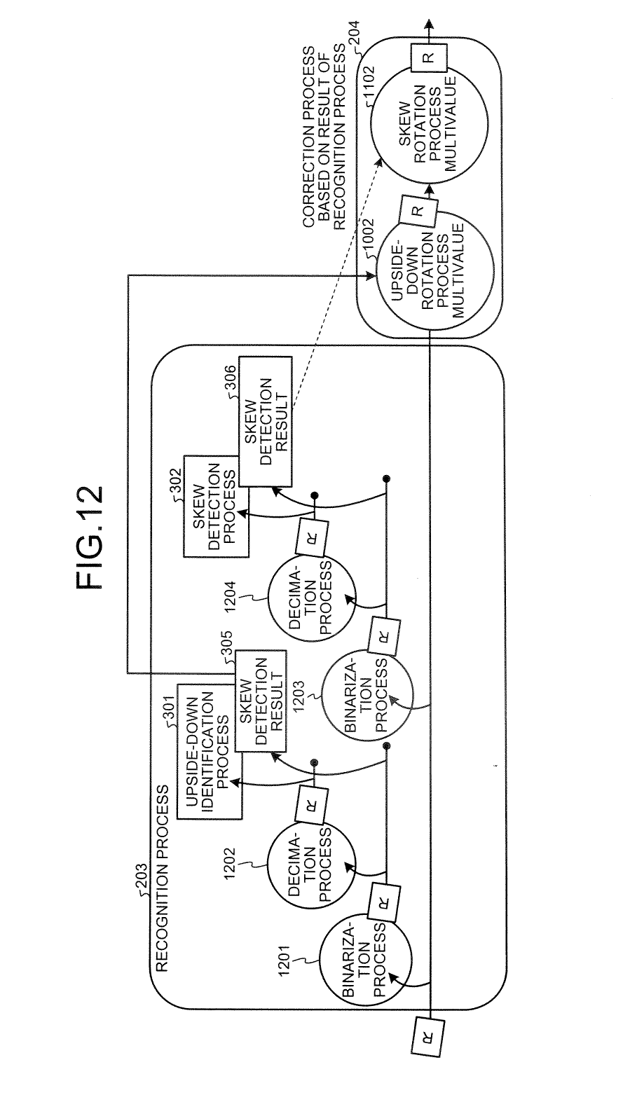

FIG. 12 depicts a relation between each process and an image direction. This drawing depicts an excerpt from the recognition process 203 and the correction process 204 based on the recognition-process result in the case of (6) in the embodiment, where the upside-down identification process 301 and the skew correction process 304 are both selected. In the upside-down identification process 301, a binarization process 1201 and a decimation process 1202 are performed as pretreatment. The upside-down identification process 301 is performed on the pretreated image, and then information about the image direction is obtained as the upside-down identification result 305.

Then, the skew detection process 302 is performed. In the skew detection process 302, a binarization process 1203 and a decimation process 1204 are performed as pretreatment. The skew detection process 302 is performed on the pretreated image, and then information about the skew angle is obtained as the skew detection result 306.

This example is targeted for a gray-scale image. An input for the binarization process 1201, the decimation process 1202, the upside-down identification process 301, the binarization process 1203, and the decimation process 1204, and the skew detection process 302 included in the recognition process 203 is an image oriented westward and slightly skewed.

In the multivalue upside-down rotation 1002 of the correction process 204 based on the recognition-process result, the image oriented westward and slightly skewed is input and serves as the upside-down identification result 305, and then the image oriented northward and slightly skewed is output. In the multivalue skew rotation 1102, an image oriented northward and slightly skewed and the skew detection result 306 are input, and then the image oriented northward is output.

Two sets of the binarization processes 1201 and 1203 and the decimation processes 1202 and 1204 are present for the upside-down identification process 301 and the skew detection process 302. This is because, in the present embodiment, different processes are applied for optimal recognition in the he upside-down identification process 301 and the skew detection process 302.

In the binarization processes 1201 and 1203, a ratio of determining that the pixel is white (white pixels/all pixel) is compared with a predetermined threshold A. If the ratio of the image is equal to or lower than the threshold, it is determined for the binary result that the image is almost white. Therefore, the decimation processes 1202 and 1204, the upside-down identification process 301, and the skew detection process 302 are omitted, and it is determined that recognition has failed. Thus, the process is terminated.

Also, in the binarization processes 1201 and 1203, a ratio of determining that the pixel is black (1−(the ratio of determining that the pixel is white)) is calculated, and is compared with a predetermined threshold B. If it is determined that the image is black, the process is terminated.

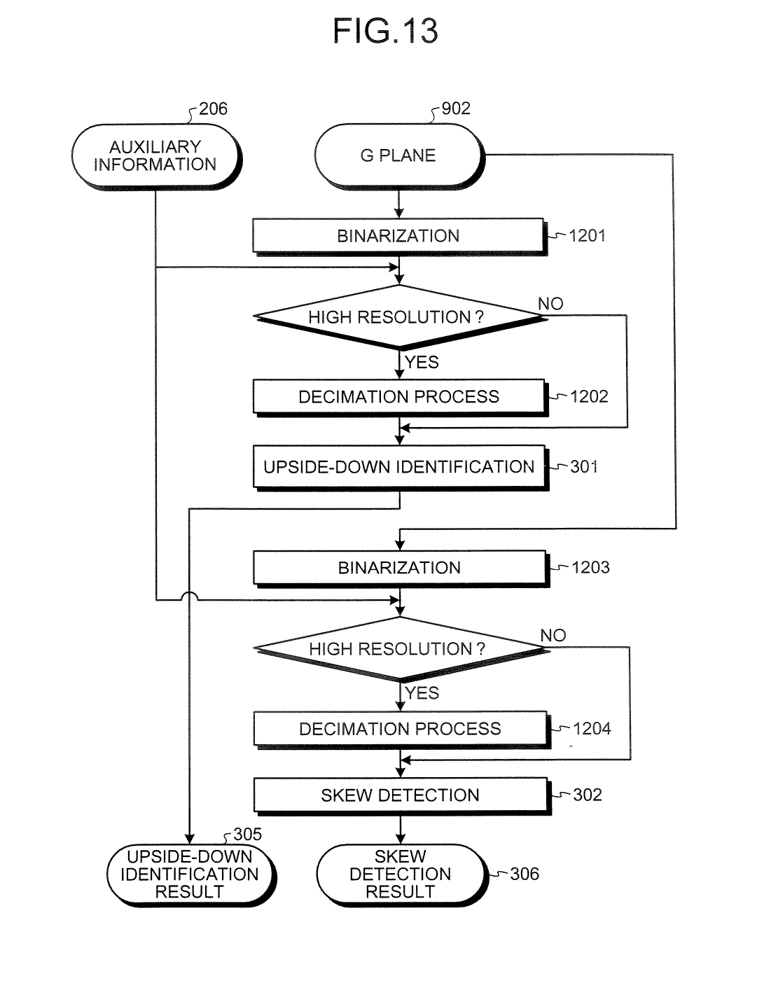

FIG. 13 depicts an entire process flow of the recognition process 203. FIG. 13 is a drawing of the process in FIG. 12 in a flowchart format. Also, the structure in FIG. 12 is such that the decimation processes 1202 and 1204 are always performed. By contrast, in the flowchart of FIG. 13, the procedure is branched on condition in the following manner. That is, by using the G plane 902 of the input image 205 and the auxiliary information 206, after the binarization processes 1201 and 1203, resolution information of the image is referred to. For an image with a ratio equal to or higher than a predetermined threshold C, the decimation process 1202 is performed. For an image with a ratio lower than the threshold C, the decimation process 1202 is not performed. For an image with a ratio equal to or higher than a predetermined threshold D, the decimation process 1204 is performed. For an image with a ratio lower than the threshold D, the decimation process 1204 is not performed.

A high-resolution image is large in image size, thereby increasing the amount of calculation and the processing time at the upside-down identification process 301 and the skew detection process 302. For an image determined as being a high-resolution image with a ratio equal to or higher than the thresholds C and D, the decimation processes 1202 and 1204 are performed for decimation and then the upside-down identification process 301 and the skew detection process 302 are performed on that decimated image. Therefore, the time required for processing a high-resolution image is reduced.

In the embodiment, the thresholds C and D for selecting whether to perform the decimation processes 1202 and 1204, which are pretreatment for the upside-down identification process 301 and the skew detection process 302, are different from each other because a relation between the resolution of the image and detection accuracy is different between the upside-down identification process 301 and the skew detection process 302.

In the decimation process 1202, a simple decimation process is performed in which one line is adopted for the main-scanning and sub-scanning I lines.

In the decimation process 1204, an OR decimation process is performed in which a region with a main-scanning J pixels by a sub-scanning K pixels is referred to determine that pixels are black even if only one black is included.

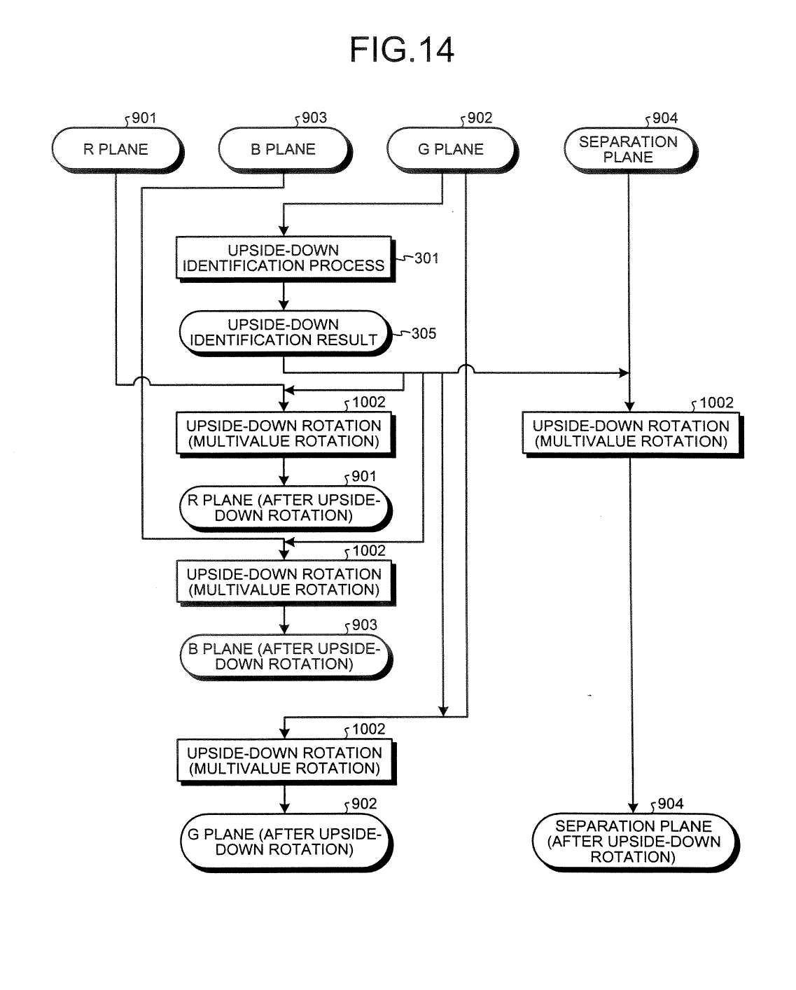

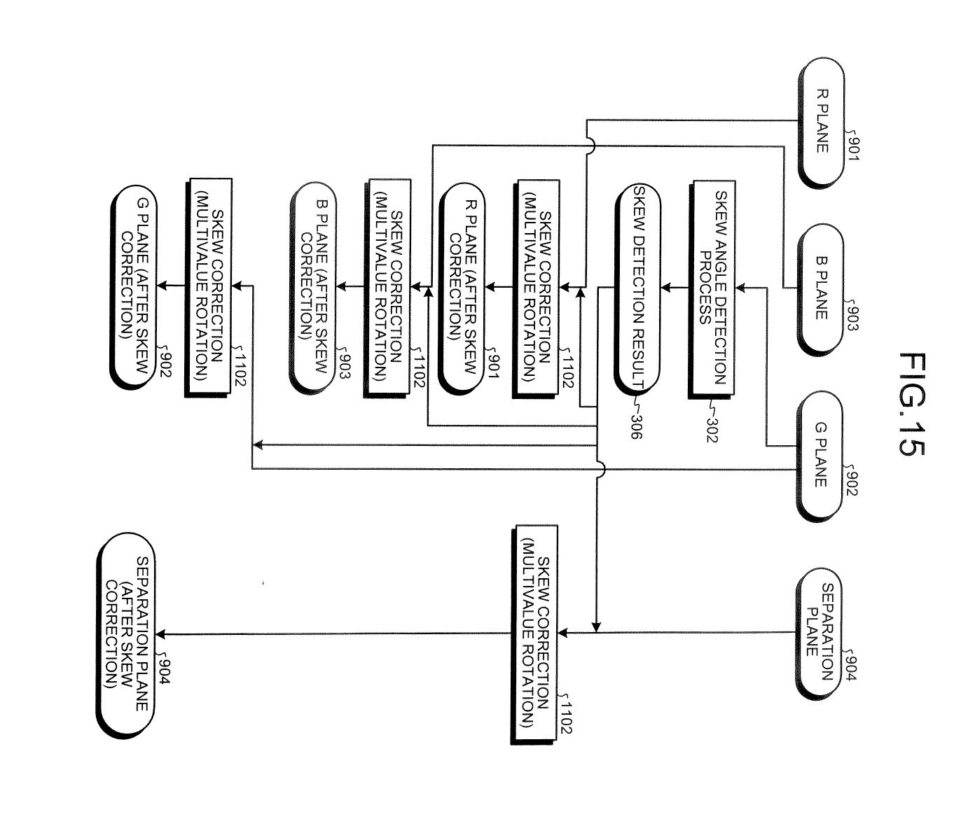

FIG. 14 depicts an example of performing the upside-down rotation process 1002 for all planes based on the detection result of the plane information obtained through the upside-down identification process 301. FIG. 15 depicts an example of performing the skew correction process 1102 on all planes based on the detection result of the plane information obtained through the skew detection process 302. In both of FIGS. 14 and 15, the G plane 902 is used for recognition process 203. This is the case of color, and the R plane 901, the G plane 902, and the B plane 903 of the input image 205 and the separation plane 904 of the auxiliary information 206 are to be rotated.

In the upside-down identification process 301 in FIG. 14, as described in the seventh and eighth embodiments, the binarization process 1201, the decimation process 1202, and the upside-down identification process 301 are put together into one process block as pretreatment.

In the skew detection process 302 in FIG. 15, as described in the seventh and eighth embodiments, the binarization process 1203, the decimation process 1204, and the skew detection process 302 are put together into one process block as pretreatment.

An advantage of using the G plane 902 in the recognition process 203 is that image data is stored in both of the case of a binary image and the case of a gray-scale image. Therefore, there is no need to switch the process depending on color-mode information, thereby simplifying the process.

Also, the process result of the single G plane 902 is reflected to the other planes. Therefore, rotating each plane based on a different upside-down identification result 305 and skew detection result 306 can be prevented. Thus, a color shift due to inconsistency in direction and a different skew angle can be prevented.

A flow of the image data (input image 205) and the auxiliary information 206 for an HDD storage application in the system is described.

In the HDD storage application, the user sets a document on the reading device 101, and provides an input to the operation display device 110 for setting a desired mode and the like and giving an instruction for starting scanner distribution.

In a control sequence, the operation display device 110 converts the information input from the user to control command data for the inside of the devices. The issued control command data is reported to the CPU via the PCI or PCI-Express bus.

Next, the CPU 106 follows the control command data for starting the HDD storage application to execute a program for an HDD application operation process.

The flow of the image data (input image 205) and the auxiliary information 206 is such that digital image data with eight bits for each of RGB obtained by the reading device 101 scanning a document has its characteristic unified into a characteristic predetermined by the first image-data processing device 102, and is then sent to the bus control device 103. Also, based on the input image 205, separation data (auxiliary information 206) is generated by the first image-data processing device 102, and is sent to the bus control device 103.

The bus control device 103 receives RGB image data (input image 205) and separation data (auxiliary information 206) from the first image-data processing device 102, and then stores the received data in the memory 107 via the CPU 106.

Next, the RGB image data (input image 205) and the separation data (auxiliary information 206) stored in the memory 107 are sent to the second image-data processing device 104 via the CPU 106 and the bus control device 103.

The second image-data processing device 104 performs the recognition process 203 and the correction process 204 based on the recognition-process result on the received RGB image data (input image 205) and separation data (auxiliary information 206).

The bus control device 103 receives the image data (input image 205) and the separation data (auxiliary information 206) from the second image-data processing device 104, and then stores the received data in the memory 107 via the CPU 106.

Next, the image data (input image 205) and the separation data (auxiliary information 206) stored in the memory 107 are sent to the HDD 105 via the CPU 106 and the bus control device 103.

The image data (input image 205) and the separation data (auxiliary information 206) stored in the HDD 105 can be reused for electronic distribution, paper output, and others.

In the recognition process 203 and the correction process 204 based on the recognition-process result at the second image-data processing device 104 according to the embodiment, it is selected based on the auxiliary information 206 whether to rotate the separation data.

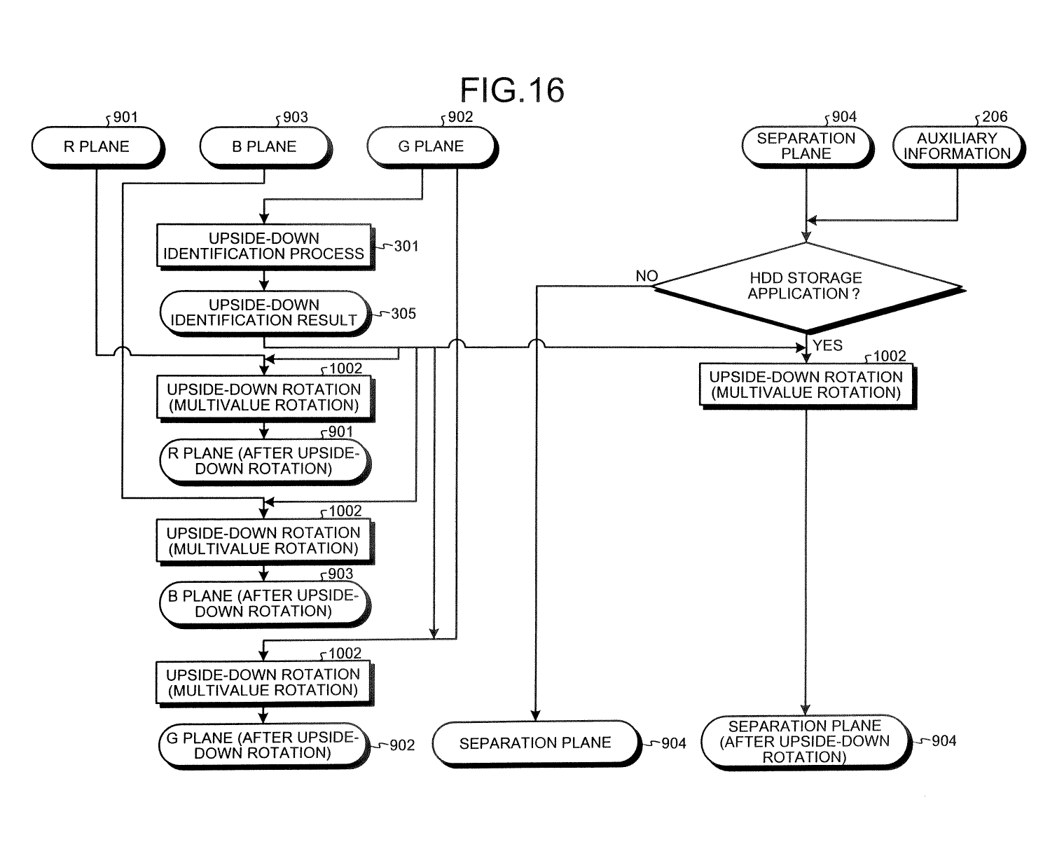

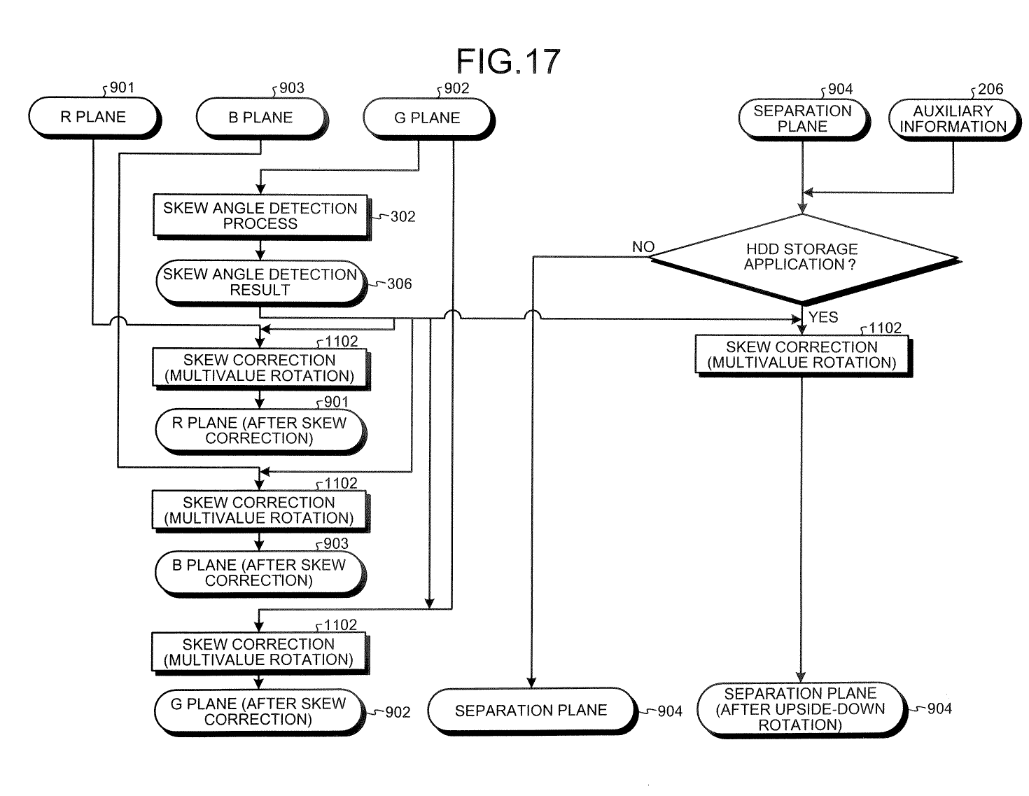

FIG. 16 depicts an example of switching whether to perform the upside-down rotation process 1002 on the separation data based on the application information in the upside-down identification process 301. FIG. 17 depicts an example of switching whether to perform the skew correction process 1102 on separation data based on application information in the skew detection process 302. These FIGS. 16 and 17 depict a case where, when color is selected as described for the structure, switching is made based on whether to perform the upside-down rotation process 1002 and the skew correction process 1102 on the separation plane 904.

The separation plane 904 is required for the filtering process 201 and the γ process 202 in the second image-data processing device 104. In the structure of FIG. 3, the correction process 204 based on the recognition-process result is positioned at the final stage. Therefore, the rotation process is not required to be performed on the separation plane 904, except for the HDD storage application that stores data in the HDD 105 for reuse.

Therefore, for copier, printer, scanner, and facsimile functions other than the HDD storage application, the separation plane 904 is not rotated.

In the HDD storage application, the image data, the separation data (auxiliary information 206), and a thumbnail (auxiliary information 206) are stored in the HDD 105. This thumbnail (auxiliary information 206) is a reduced image for display as a list generated from the image data by the CPU after the second image-data processing device 104 ends the image processing.

Image data output from the second image-data processing device 104 at the time of the end of the image processing represents an image subjected to the upside-down rotation process 1002 and the skew correction process 1102. Therefore, a thumbnail subjected to the upside-down rotation process 1002 and the skew correction process 1102 can be generated at the HDD storage application based on the application information of the auxiliary information 206.

Also, with (1) to (6), even if the user sets the image direction but does not select the skew correction process, the CPU 106 causes a thumbnail image to be generated from the output result of the second image-data processing device 104 irrespectively of whether the upside-down identification process 301 and the skew correction process 304 are selected.

This thumbnail image is displayed on the operation display device 110 at the time of selection from the HDD-stored documents for reuse. Also, when an image in the HDD 105 is selected by a driver of the client PC, this thumbnail image is displayed on a display device connected to the client PC, thereby allowing the user to select the image.

When the user selects the upside-down identification process 301, the skew correction process 304, or both, the second image-data processing device 104 performs the upside-down rotation process 1002 and the skew correction process 1102. By using the image, the CPU 106 causes a thumbnail image to be generated. Thus, in the HDD 105, the image after upside-down rotation of the correction process 204 based on the recognition-process result, and the thumbnail image after skew correction are stored. At the time of selection, the user can view the image after upside-down rotation and the thumbnail image after skew correction.

In the exemplary embodiments described in the foregoing for implementing the present invention, the recognition process 203 includes the upside-down identification process 301 and the skew detection process 302. Alternatively, the recognition process 203 may also include a character recognition process through OCR and a bar-code recognition process. Also, text data may be added to the auxiliary information 206 and stored in the HDD serving as a secondary storage device. When the user selects an image stored in the HDD 105, a text search may be performed for improving search efficiency.

According to an aspect of the present invention, an image processing apparatus includes an image reading device that obtains electronic image data obtained by reading a document, an image writing device that prints the image data on transfer paper, a memory device that stores the image data and auxiliary data of the image data, an external I/F device that transmits and receives the image data to and from an external device, a first image-data processing device that processes the image data from the image reading device, a second image-data processing device that processes the image data from the memory device, and a bus control device that connects each of the devices. Also, the first image-data processing device unifies characteristics of the image data so that the image data can be used by both of the image writing device and the external device. Then, the characteristically-unified image data is stored in the memory device. The second image-data processing device performs an image processing recognition process, and a correction process based on the result of the recognition process so that the processed image data has a characteristic suitable for output to the image writing device and the external I/F device. As such, based on the image data unified by the first image-data processing device at a previous stage, the second image-data processing device performs a recognition process through image processing. With this, the recognition process can be performed suitably for the unified image data. For this reason, development efficiency of the recognition process is increased, and a method of achieving the recognition process is simplified into a single process. Image processing for all applications assumed, such as copier, printing, scanner, facsimile, and HDD storage applications, is performed at the second image-data processing device, and therefore all applications are supported because each function is within an image processing path without exception. Furthermore, images input to the second image-data processing device are unified, and a final output image is no longer subjected to image processing. Therefore, a detection process of a recognition process can be simplified. Also, a process of reflecting the recognition-process result is separated to be performed on the final output image. Therefore, an image recognition process can be incorporated without other influences of the image processing performed at the second image-data processing device. In consideration of reuse, the process of reflecting the recognition-process result is performed not only on the image data, but also on the auxiliary information of the image data. Therefore, the image data and its auxiliary information can be stored in the HDD, thereby making it possible to optimally perform image processing at the time of reuse. In the case of an application, such as a copier, where data is once stored in the HDD and is not used anymore, a detection process is performed at a previous stage, and then image processing is performed so that the data has a characteristic suitable for output. Then at the final stage, rotation is performed only on image data that requires rotation. Here, the image processing for achieving a characteristic suitable for output is performed by using the image data and the auxiliary information, but a detecting unit and a process of reflecting the recognition result by the detecting unit are separated from the image processing. With this, a rotation process on the auxiliary information can be omitted, thereby increasing the processing speed.

According to another aspect, an image processing apparatus includes an image reading device that obtains electronic image data obtained by reading a document, an image writing device that prints the image data on transfer paper, a memory device that stores the image data and auxiliary data of the image data, an external I/F device that transmits and receives the image data to and from an external device, a first image-data processing device that processes the image data from the image reading device, a second image-data processing device that processes the image data from the memory device, and a bus control device that connects each of the devices. Also, the first image-data processing device unifies characteristics of the image data so that the image data can be used by both of the image writing device and the external device. Then, the characteristically-unified image data is stored in the memory device. The second image-data processing device performs an image upside-down identification process and a skew detection process and an upside-down rotation process and a skew correction process based on the result of the image upside-down identification process and the skew detection process so that the processed image data has a characteristic suitable for output to the image writing device and the external I/F device. As such, based on the image data unified by the first image-data processing device at a previous stage, the second image-data processing device performs a recognition process through image processing. With this, the upside-down identification process and the skew detection process can be performed suitably for the unified image data. For this reason, development efficiency of the upside-down identification process and the skew detection process is increased, and a method of achieving the upside-down identification process and the skew detection process is simplified into a single process. Image processing for all applications assumed, such as copier, printing, scanner, facsimile, and HDD storage applications, is performed at the second image-data processing device, and therefore all applications are supported because each function is within an image processing path without exception. Furthermore, images input to the second image-data processing device are unified, and a final output image is no longer subjected to image processing. Therefore, the upside-down identification process and the skew detection process can be simplified. Also, a process of reflecting the results of upside-down rotation and skew correction is separated to be performed on the final output image. Therefore, an image recognition process can be incorporated without other influences of the image processing performed at the second image-data processing device. In consideration of reuse, the upside-down rotation process and the skew correction process are performed not only on the image data, but also on the auxiliary information of the image data. Therefore, the image data and its auxiliary information can be stored in the HDD, thereby making it possible to optimally perform image processing at the time of reuse.

According to still another aspect, an operation display device that allows a user to select ON or OFF for selection and execution of an upside-down identification process and a skew correction process is provided. With this, a user who does not desire an upside-down identification process, a skew correction process, or both can skip these functions, thereby reducing processing time. Also, even for the purpose of use in which only the upside-down identification process or the skew correction process is requested with the use of an application selected, the present invention can be applied without almost any change in structure, thereby increasing development efficiency and reducing processing time.

According to the present invention, the results of the upside-down rotation process and the skew correction process at the second image-data processing device are reflected on header information by using an image direction and a rotation angle included in the Portable Document Format (PDF) as standard. Without actually rotating an actual image, a virtually-rotated image is present on a viewer. Thus, a time required for the upside-down rotation process and the skew correction process can be reduced.

According to still another aspect, the results of the skew correction process at the second image-data processing device are reflected on header information by using an amount of image movement included in the Portable Document Format (PDF) as standard. Without actually parallel-translating an actual image, a virtually-parallel-translated image is present on a viewer. Thus, a time required for the skew correction process can be reduced. Also, parallel translation is performed based on a rotation origin in consideration of a skew angle, a loss of image information can be prevented as much as possible.

According to still another aspect, an image processing apparatus includes an image reading device that obtains electronic image data obtained by reading a document, an image writing device that prints the image data on transfer paper, a memory device that stores the image data and auxiliary data of the image data, an external I/F device that transmits and receives the image data to and from an external device, a first image-data processing device that processes the image data from the image reading device, a second image-data processing device that processes the image data from the memory device, and a bus control device that connects each of the devices. Also, the first image-data processing device unifies characteristics of the image data so that the image data can be used by both of the image writing device and the external device. Then, the characteristically-unified image data is stored in the memory device. The second image-data processing device performs an image upside-down identification process and a skew detection process and an upside-down rotation process and a skew correction process based on the result of the image upside-down identification process and the skew detection process so that the processed image data has a characteristic suitable for output to the image writing device and the external I/F device. For the upside-down identification process and the skew detection process, if detection and rotation processes are performed at the previous stage of the second image-data processing device, not only the image data but also separation data, which is auxiliary information, is rotated. With this, detrimental effects of other image processing performed at the second image-data processing device for making the characteristic suitable for output can be prevented. Furthermore, also for the HDD storage application not intended for immediate output, the image data and its auxiliary information, that is, the separation data, are rotated before stored in the HDD. With this, at the time of later reuse, detrimental effects of image processing performed at the second image-data processing device for making the characteristic suitable for output can be prevented.

According to still another aspect, the upside-down identification process and the skew correction process are not performed when it is determined at the previous stage of the detection process that the document is blank without image information. With this, processing time required for the detection process can be reduced.

According to still another aspect, for the upside-down identification process and the skew correction process, when it is determined at the previous stage of the detection process based on the auxiliary information of the image that the document has a high-resolution image, the image is decimated for the detection process. With this, processing time required for -the detection process can be reduced. Although the amount of information of the image itself is decreased by decimating the image, the high-resolution image originally has a large amount of information. Therefore, there is a low possibility of erroneous recognition due to a decrease in image information caused by decimation.

According to still another aspect, for the upside-down identification process and the skew correction process, even if there are a plurality of pieces of image plane information as in a full-color image, only one plane is used for the detection process. With this, processing time required for the detection process can be reduced. Also, binary or gray-scale images can be processed in a manner similar to that of a process on image information originally having one plane. Therefore, development efficiency is increased, and a scheme of achieving the process is simplified with a single process.

According to still another aspect, an image processing apparatus includes an image reading device that obtains electronic image data obtained by reading a document, an image writing device that prints the image data on transfer paper, a memory device that stores the image data and auxiliary data of the image data, an external I/F device that transmits and receives the image data to and from an external device, a first image-data processing device that processes the image data from the image reading device, a second image-data processing device that processes the image data from the memory device, and a bus control device that connects each of the devices. Also, the first image-data processing device unifies characteristics of the image data so that the image data can be used by both of the image writing device and the external device. Then, the characteristically-unified image data is stored in the memory device. The second image-data processing device performs an image upside-down identification process and a skew detection process and an upside-down rotation process and a skew correction process based on the result of the image upside-down identification process and the skew detection process so that the processed image data has a characteristic suitable for output to the image writing device and the external I/F device. For the upside-down identification process and the skew detection process, if detection and rotation processes are performed at the previous stage of the second image-data processing device, not only the image data but also separation data, which is auxiliary information, is rotated. With this, detrimental effects of other image processing performed at the second image-data processing device for making the characteristic suitable for output can be prevented. Furthermore, also for the HDD storage application not intended for immediate output, the image data and its auxiliary information, that is, the separation data, are rotated before stored in the HDD. With this, at the time of later reuse, detrimental effects of image processing performed at the second image-data processing device for making the characteristic suitable for output can be prevented. Furthermore, the rotation process is performed before storage in the HDD. Therefore, even if the data is reused a plurality of time, it is sufficient to perform the rotation process only once before storage in the HDD, thereby increasing the speed of the process.

According to still another aspect, an image processing apparatus includes an image reading device that obtains electronic image data obtained by reading a document, an image writing device that prints the image data on transfer paper, a memory device that stores the image data and auxiliary data of the image data, an external I/F device that transmits and receives the image data to and from an external device, a first image-data processing device that processes the image data from the image reading device, a second image-data processing device that processes the image data from the memory device, and a bus control device that connects each of the devices. Also, the first image-data processing device unifies characteristics of the image data so that the image data can be used by both of the image writing device and the external device. Then, the characteristically-unified image data is stored in the memory device. The second image-data processing device performs an image upside-down identification process and a skew detection process and an upside-down rotation process and a skew correction process based on the result of the image upside-down identification process and the skew detection process so that the processed image data has a characteristic suitable for output to the image writing device and the external I/F device. For the upside-down identification process and the skew detection process, if detection and rotation processes are performed at the previous stage of the second image-data processing device, not only the image data but also separation data, which is auxiliary information, is rotated. With this, detrimental effects of other image processing performed at the second image-data processing device for making the characteristic suitable for output can be prevented. Furthermore, also for the HDD storage application not intended for immediate output, the image data and its auxiliary information, that is, the separation data, are rotated before stored in the HDD. With this, at the time of later reuse, detrimental effects of image processing performed at the second image-data processing device for making the characteristic suitable for output can be prevented. Furthermore, the rotation process is performed before storage in the HDD. Therefore, even if the data is reused a plurality of time, it is sufficient to perform the rotation process only once before storage in the HDD, thereby increasing the speed of the process. Even when a thumbnail image is generated from the image stored for thumbnail display, the image subjected to upside-down rotation and skew correction is stored without determining whether upside-down identification or skew correction has been performed, and a thumbnail image is then generated from the image. Therefore, processing can be unified and simplified without requiring complex control, thereby increasing development efficiency.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an image reading unit that obtains image data by scanning a document;
an image writing unit that prints the image data on a recording medium;
a storage unit that stores the image data and auxiliary information relating to the image data;
a transmitting/receiving unit configured to transmit the image data to an external device and receive image data from the external device;
a first image data processing unit that processes the image data obtained by the image reading unit;
a second image data processing unit that processes the image data present in the memory unit; and
a bus control unit that connects each of the units, wherein
a recognition function through image processing and an image processing function based on the recognition result are independently provided.

2. The image processing apparatus according to claim 1, wherein the recognition function through image processing at the second image data processing unit includes at least one of an upside-down identification process and a skew correction process.

3. The image processing apparatus according to claim 2, wherein
in the recognition function through image processing at the second image data processing unit,
for an upside-down identification detection process of the upside-down identification process and a skew angle detection process of the skew correction process, either ON or OFF of the upside-down identification process and the skew correction process can be selected through an operation display unit.

4. The image processing apparatus according to claim 2, wherein
in the second image data processing unit,
when electronic data is distributed to a client PC and a file output format is a PDF format, instead of performing rotation based on the upside-down identification process and the skew correction process, rotation information is written in a header of a PDF file, and rotation is made by a viewer at a client PC side.

5. The image processing apparatus according to claim 2, wherein
in the second image data processing unit,
when electronic data is distributed to a client PC and a file output format is a PDF format, instead of performing a parallel translation process based on the skew correction process, amount-of-movement information is written in a header of a PDF file, and parallel translation is made by a viewer at a client PC side.

6. The image processing apparatus according to claim 2, wherein
in the recognition function through image processing at the second image data processing unit,
a rotation process based on the upside-down identification process and the skew correction process has a function of rotating the image data and the auxiliary information.

7. The image processing apparatus according to claim 2, wherein
in the recognition function through image processing at the second image data processing unit,
in the upside-down identification process and the skew correction process, when it is determined that the document is blank without image information, a detection process and a rotation process are not performed.

8. The image processing apparatus according to claim 2, wherein
in the recognition function through image processing at the second image data processing unit,
in the upside-down identification process and the skew correction process, a detection process is performed on a high-resolution image by decimating image information.

9. The image processing apparatus according to claim 2, wherein
in the recognition function through image processing at the second image data processing unit,
for a full-color image, only one of planes for colors forming the full-color image is subjected to the upside-down identification process and the skew detection process, and the result is applied to the other planes for upside-down rotation and skew rotation.

10. The image processing apparatus according to claim 2, wherein
in the recognition function through image processing at the second image data processing unit,
the upside-down identification process and the skew correction process include a function of determining whether to rotate the auxiliary information based on the auxiliary information and, when the image data is stored in a secondary storage unit, the image data and the auxiliary information are rotated for correction and then stored in the secondary storage unit.

11. The image processing apparatus according to claim 2, wherein
in the recognition function through image processing at the second image data processing unit,
in the upside-down identification process and the skew correction process, when the image data is stored in a secondary storage unit, the image data and the auxiliary information are rotated for correction, and a thumbnail rotated for correction is displayed.
